(19) United States
(12) Patent Application Publication
(10) Pub. No.: US 2012/0130805 A1
(43) Pub. Date: May 24, 2012

(54) SELECTING MEDIA ADVERTISEMENTS FOR PRESENTATION BASED ON THEIR PREDICTED PLAYTIMES

(75) Inventors: Robert On, Cupertino, CA (US); Steve Scott, Mountain View, CA (US)

(73) Assignee: Google Inc., Mountain View, CA (US)

(21) Appl. No.: 12/949,105

(22) Filed: Nov. 18, 2010

(51) Int. Cl. G06Q 30/00

(52) U.S. Cl. 705/14.49; 705/14.68

(57) ABSTRACT

Advertisers provide bids for presenting temporal media ads along with content presented to users. The bids presented comprise a cost per unit time of presentation of the temporal media ad. Advertisers specify target audience and target media content for presenting their ads. A candidate set of ads is selected for presentation to the user along with requested content based on the temporal media ad targeting criteria. Machine learning techniques are used for predicting playtimes of ads based on features extracted from user attributes, content, and time of presentation. A winning temporal media ad is selected from the candidate set of ads based on predicted playtimes of ads in the candidate set of ads. An auction scheme is used for selecting a winning temporal media ad from the candidate ads.

### FIELD OF THE INVENTION

This invention relates to online advertiser bidding and selection of advertisements for presentation with content.

### BACKGROUND

Online advertising is a significant source of earnings for many Internet based businesses. Online business operators providing free online services such as search, email, social networking capabilities and the like typically make revenue from advertising provided in conjunction with such free services. The accuracy of the cost model used for charging an online advertiser plays a significant role in attracting advertisers to a website displaying advertisements. The same cost models can also be used for other systems that support advertising, for example, systems presenting audio advertisements. Several cost models exist for determining the cost that an advertiser pays to a website displaying the advertisement to an end user.

The cost per mille (CPM) model requires the advertiser to pay for the amount of exposure of their message to the users of the online business operator's services. An impression of an advertisement is an appearance of an advertisement in web content (e.g., a web page or other web format) for presentation to a user. “Per mille” refers to thousand impressions. An advertiser pays the online business operator for the number of times the advertisement is shown in web content presented to end users. The CPM model does not provide a measure of how successful an advertisement campaign is, only a measure of presentations.

A cost per action (CPA) model requires the advertiser to pay to present the advertisement only if a user completes a transaction, for example, a purchase with the advertiser. The CPA model places the burden of success of the advertisement on the Internet business operator presenting the advertisement. The online business operator presenting the advertisement earns revenue only if the advertisement is successful in achieving the goal of the advertiser, for example, a sale or sign-up of customers.

In the cost per click (CPC) model, the advertiser pays each time a user clicks on their advertisement. Accordingly, the number of impressions of the advertisement is not significant unless a user clicks on the advertisement presented in an impression. The CPC model places the burden of success of an advertisement on both the online business operator presenting the advertisement and the advertiser. If the advertisements are presented to users in a random fashion resulting in very few clicks from the users, the online business operator presenting the advertisement gets paid less. Hence, the online business operator presenting the advertisements has motivation to present advertisements in contexts where the end user is likely to pay attention to the advertisements. However, once the user clicks on the advertisement, it is the advertiser's responsibility to make sure the user completes a transaction. If the user clicks on the advertisement and is redirected to the advertiser but does not complete the transaction, the advertiser pays the online business operator presenting the advertisement but does not achieve the goal of advertising.

In the CPC model, the advertiser and the online business operator can agree upon a fixed price for each click. Alternatively, advertisers can bid on keywords for presenting their advertisements on services that provide keyword based searches to end users. An advertiser placing a bid agrees to pay the amount bid if the advertisement is displayed to a user or the user clicks on the advertisement. The online business operator may display an advertisement when a keyword based query matches the keywords that an advertiser has paid for. For example, search engines display sponsored links next to search results ordered by relevancy.

Advertisements that present temporal media content, such as video, audio, animated, or interactive ads to users present new challenges in terms of accurately measuring their costs based on the value provided to the advertisers. For example, advertisements based on media can allow a user to skip the advertisement after viewing the advertisement partially. When a user skips a temporal media ad after watching it partially, the message in the temporal media ad can be considered conveyed partially. The above cost models do not capture the value provided by such media ads to users.

### SUMMARY

Computer-implemented methods, computer systems, and computer program products provide for selection of temporal media ads for presentation with online content. In one embodiment, bids are received from advertisers for presenting temporal media ads along with online content to a user. Each bid is based upon a cost per unit time of presentation of the temporal media ad. The system selects an online content for presentation to a user. A candidate set of temporal media ads is determined for presentation to the user along with the online content. A predicted playtime by the user is determined for each temporal media ad in the candidate set of temporal media ads based on previous playtimes of temporal media ads by users when presented with temporal media ads. A temporal media ad is selected from the candidate set of temporal media ads based on the predicted playtime of each temporal media ad and the cost per unit time of presentation of each temporal media ad.

The user is presented with the selected temporal media ad along with the online content. The cost of presenting the temporal media ads that is charged to the advertiser is determined based on the actual playtime of the ads by the user. The selection of the ads from the set of candidate ads is based on an auction scheme, for example, a second price auction scheme. Where a second price auction scheme is used for selecting a temporal media ad for presentation, the cost charged to the advertiser of the selected temporal media ad is based on the cost per unit time of a runner-up temporal media ad and the predicted playtime of the selected temporal media ad and the runner up temporal media ad.

In some embodiments, the advertisers provide temporal media ad targeting criteria specifying the type of users of the online content for targeting the ads. The set of candidate temporal media ads for presentation to the user is determined by matching the attributes of the user with attributes of target audience provided by advertisers. Similarly, the set of candidate ads for presentation with an online content is determined by matching the attributes of the online content with attributes of target content provided by advertisers.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level diagram of a system environment for selecting temporal media ads for presentation with online content based on predicted playtime of the temporal media ads according to one embodiment of the invention.

FIG. 2 is a high-level block diagram illustrating a detailed view of modules within an advertisement subsystem that allows selection of temporal media ads according to one embodiment of the invention.

FIG. 3 shows a data flow diagram illustrating the interaction between various types of data stored in the advertisement subsystem for training a model for predicting playtime for ads, according to one embodiment of the invention.

FIG. 4 shows a data flow diagram illustrating the interaction between various types of data stored in the advertisement subsystem for determining a winning temporal media ad from a set of selected ads for presentation to a user along with online content, according to one embodiment of the invention.

FIG. 5 is a high-level block diagram illustrating an example of a computer for use in the computing environment shown in FIG. 1 according to one embodiment of the present disclosure.

The figures and the following description describe certain embodiments by way of illustration only. One skilled in the art will readily recognize from the following description that alternative embodiments of the structures and methods illustrated herein may be employed without departing from the principles described herein.

### DETAILED DESCRIPTION

### Introduction

Advertisers utilize online-streaming media for presenting advertisements (ads) to users of internet or other technologies that allows for experiencing temporal media, such as audio recordings, videos, animations, interactive media, and so forth. For example, a user that requests to view a video hosted by a video hosting service may be presented with a video temporal media ad before the user is allowed to view the requested video, while the video is playing, or in between segments of the video. The user may be allowed to skip the temporal media ad after viewing the temporal media ad partially. A service provider that presents ads to users and charges advertisers for presenting the ads is more likely to attract advertisers if the cost paid by the advertisers is proportionate to the value received by the advertisers. A measure of the value received by an advertiser for a temporal media ad presented to a user is based on the length of time the temporal media ad was viewed by the user.

Embodiments of an advertisement system for online-streaming media charge advertisers based on the length of time that a temporal media ad is viewed by a user. Advertisers present bids based on cost per second that they are willing to pay for presentation of their ads. The actual revenue generated by presenting the temporal media ad is known after the temporal media ad is presented to a user based on the actual playtime of the temporal media ad. A winning temporal media ad is selected from a set of candidate ads based on estimates of revenue determined from predicted playtimes of candidate ads. An auction strategy is used for selecting the winning temporal media ad, for example, a generalized second price auction strategy. Machine learning techniques are used to predict playtime of ads based on information collected from historical data, for example, attributes describing the user, attributes of the online content, time of presentation and the like.

### System Environment

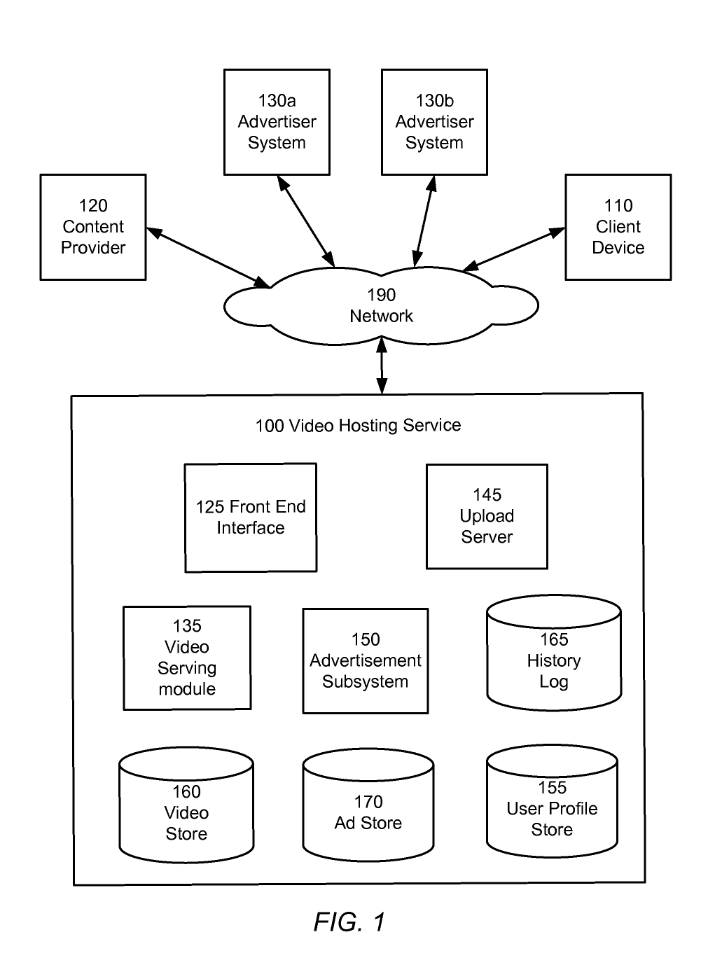

FIG. 1 is a high-level diagram of a video hosting service that provides playtime based bidding and temporal media ad selection for video ads according to one embodiment. The video hosting service 100 stores and provides videos to the client devices 110. Content providers provide videos served by the video hosting service, for example, videos for entertainment, videos presenting news, educational videos and the like. Although the concepts herein describe the example of video ads presented with videos requested by users, the concepts can be extended to other types of temporal media ads presented with online content requested by users, for example, audio content, image content, or text content. Advertisers, using advertiser systems 130a, 130b provide video ads to video hosting service 100 for presentation by the system in conjunction with videos provided to users of the system. (A letter after a reference numeral, such as “130a,” indicates that the text refers specifically to the element having that particular reference numeral, while a reference numeral in the text without a following letter, such as “130,” refers to any or all of the elements in the figures bearing that reference numeral.) Each advertiser provides bids indicating how much the advertiser will pay per unit time to have its ads presented to a user.

The video hosting service 100 receives a request from a client device 110 requesting presentation of a video. The video hosting service 100 determines a temporal media ad (or ads) to be presented along with the requested video. The selection of the temporal media ad is based on predicted playtime of ads and the bids for ads provided by the advertisers. The video hosting service 100 sends the video and the temporal media ad to the client device 110.

Client devices 110 are computing devices that execute client software, e.g., a web browser or built-in client application, to connect to the front end interface 125 of the video hosting service 100 via a network 190 and to display videos. The client device 110 might be, for example, a personal computer, a personal digital assistant, a cellular, mobile, a smart phone, a laptop computer, a television “set-top box,” and the like. In some embodiments, the client 110 includes an embedded media player such as, for example, the FLASH player from Adobe Systems, Inc. or any other player adapted for the media file formats used in the video hosting service 100.

The content provider 120 operates a client device to perform content provider functions including, uploading a video file to the video hosting service 100, editing a media file stored by the video hosting service 100, or editing content provider preferences associated with a media file. Note that the terms “client,” “advertiser system,” and “content provider” are used herein may refer to software providing respective functionality, to hardware on which the software executes, or to the entities operating the software and/or hardware, as is apparent from the context in which the terms are used.

The network 190 is typically the Internet, but may be any network, including but not limited to a LAN, a MAN, a WAN, a mobile wired or wireless network, a private network, or a virtual private network. In one embodiment, the network 190 uses standard communications technologies and/or protocols. For example, the networking protocols used on the network 190 can include the transmission control protocol/Internet protocol (TCP/IP), the hypertext transport protocol (HTTP), the file transfer protocol (FTP), etc. The data exchanged over the network 190 can be represented using technologies and/or formats including the hypertext markup language (HTML), the extensible markup language (XML), etc. In some embodiments, the entities can use custom and/or dedicated data communications technologies instead of, or in addition to, the ones described above.

The video hosting service 100 comprises a front end interface 125, a video store 160, a temporal media ad store 170, a video serving module 135, a history log 165, a user profile store 155, an upload server 145, and an advertisement subsystem 150. Other conventional features, such as firewalls, load balancers, authentication servers, application servers, failover servers, site management tools, and so forth are not shown so as to more clearly illustrate the features of the video hosting service 100. The illustrated components of the video hosting service 100 can be implemented as a combination of hardware and software. In general, functions described in one embodiment as being performed by one component can also be performed by other components in other embodiments, or by a combination of components.

The upload server 145 of the video hosting service 100 receives videos from content providers 120 and stores them in video store 160. In response to requests from clients 110, the video serving module 135 provides videos from the video store 160 to the clients 110. The video store 160 stores data and metadata for videos received from content providers 120. Each video file stored in video store 160 has a unique identifier that distinguishes it from each of the other media files, such as a textual name (e.g., the alphanumeric string “p23 as56q”), an integer, or any other way of uniquely identifying a media file. The media files can be packaged in various containers such as WAV (waveform audio file format), AIFF (audio interchange file format), AVI (audio video interleave), MP4, or MOV, MPEG-TS (moving picture experts group transport stream), and can be encoded using codecs such as WMA (windows media audio), WMV (windows media video), MPEG-1, MPEG-2, MPEG-4, H.264, H.263, and the like.

The front end interface 125 provides the interface between client 110 and the various components of video hosting service 100. For example, the client 110 can use the front end interface 125 to request videos from the video hosting service. The front end interface 125 also provides the interface for content providers 120 to upload videos to the video hosting service 100 and the interface for the advertisers 130 to upload ads and information describing the ads including temporal media ad targeting criteria and bids for ads.

Content providers 120 can provide metadata comprising different types of information describing the videos. For example, metadata tags can describe the language used in the video, keywords describing the video, the quality of the video, an artist performing in the video, the type of the video e.g., a sports video, an entertainment video, or an educational video, subscription information describing whether video is premium content or user generated content and the like. Other examples of metadata for videos include information describing demographic information of the target audience, for example, a particular ethnic background or an age group that the video is targeted towards. Some type of metadata can be inferred from historical patterns of users viewing a video, for example, typical age groups or geographical distribution of users interested in the video.

The user profile store 155 stores information describing users of the video hosting service 100. The video hosting service 100 may require users to register with the video hosting service 100. As part of registration or later, the user may be asked to provide information including, interests of the user, education, demographic information, for example, age, gender, location, and the like. In an embodiment, the video hosting service 100 may use an external system for obtaining user profile information.

The temporal media ad store 170 stores data and metadata associated with ads that are provided by advertisers 130. A temporal media ad can be stored in formats similar to those described above for storing videos. The advertiser providing the temporal media ad can specify as part of metadata associated with the temporal media ad, whether the temporal media ad can be skipped. The temporal media ad can either be skipped entirely or skipped after the user has viewed a portion of the temporal media ad. Alternatively, a user can be allowed to forward through portions of the temporal media ad or view selected portions of the temporal media ad. A temporal media ad can be presented before or during the video presented to the user but can be presented at any time associated with the media, for example, spliced with the video. In other embodiments, ads can be presented with other types of content, for example, a web page displaying information.

The temporal media ad store 170 also stores temporal media ad targeting criteria provided by the advertisers for a temporal media ad. The temporal media ad targeting criteria specifies the types of audience to whom the advertiser wants to present a temporal media ad. The temporal media ad targeting criteria can be user-based or content-based temporal media ad targeting criteria. User-based temporal media ad targeting criteria specify attributes of the types of user that the advertiser 130 wants to target for presenting the temporal media ad. Attributes of users that can be specified by an advertiser 130 include user's age, gender, location, or language. Content-based temporal media ad targeting criteria specify attributes of the type of content that is being presented to a user. For example, an advertiser may specify a genre of music, a specific television series, a specific artist, a category of video content, or premium vs. user-generated content as attributes for targeting ads. In some embodiments, the advertiser 130 is allowed to specify temporal criteria, for example, time of the day or day of the week when the temporal media ad should be shown. The advertiser 130 can also specify spatial criteria, for example, geographical regions where the temporal media ad should be presented.

The video serving module 135 provides runtime support for streaming videos to the client device 110 of a user requesting the video. The video server 135 can verify if a user is authorized to view the video based on criteria including authentication information of user (e.g., login and password), subscription level of user, age of user, payment information, or other demographic factors specified by the content provider to target media content.

The video hosting service 100 further comprises a history log 165 that stores a record of videos presented to users, advertisements presented, and any associated events or statistics. For example, the history log 117 can store a time at which a video was played, an identifier (e.g., a unique username) of a user who viewed it, and identifiers of any ads that were presented in association with it. Similarly, the history log 165 stores a time at which each temporal media ad was presented, the identifier of a video in association with which it was presented, the identifier of a user to whom it was presented, and actions taken on the temporal media ad (e.g., whether the user skipped the temporal media ad after viewing a portion of the temporal media ad and the length of time that the temporal media ad was viewed). The history log 165 may, for convenience of later computations, further store additional aggregated information (e.g., summations, counts, averages, variances, rates, and so forth) for either individual ads, or across the population of ads, derivable from other data within the log, such as a total number of presentations of a temporal media ad, average viewing time of specific ads, and so on.

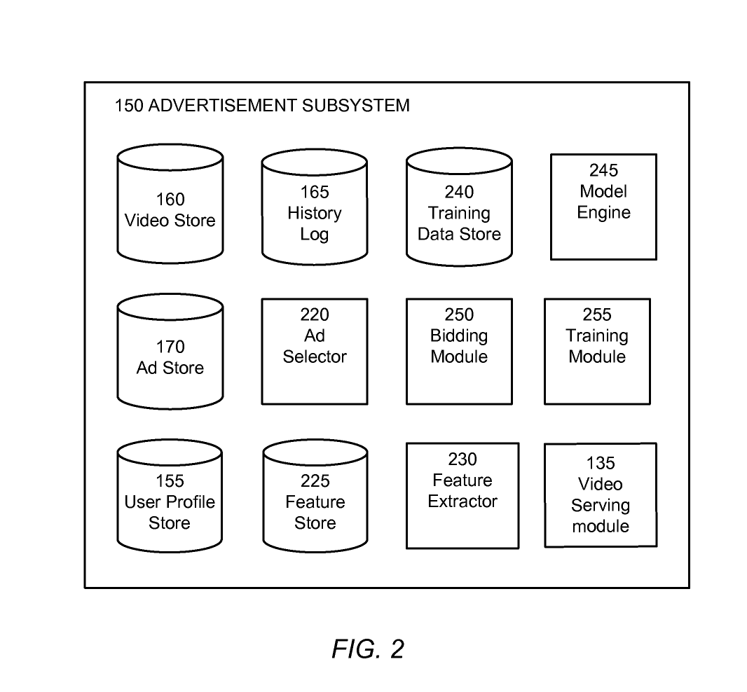

The advertisement subsystem 150 determines ads that are presented with content requested by users. The advertisement subsystem 150 uses machine learning methods to predict playtime of ads by users requesting content. The advertisement subsystem 150 uses the predicted playtime along with bids for ads provided by advertisers to select one or more winning ads based on an auction strategy. The winning ads are presented to the user along with the requested videos. The advertisement subsystem 150 is described in more detail with respect to FIG. 2, below.

### Architectural Overview of Advertisement Subsystem

FIG. 2 is a high-level block diagram illustrating a detailed view of modules within an advertisement subsystem 150 for determining the ads to be presented to a user. Some modules presented in the video hosting service 100 of FIG. 1 are accessed by the advertisement subsystem 150 and are presented as part of the advertisement subsystem 150. The advertisement subsystem 150 includes a temporal media ad selector 220, a feature extractor 230, a video store 160, a user profile store 155, a temporal media ad store 170, a training data store 240, a training module 255, a feature store 225, a video serving module 135, a model engine 245, a bidding module 250, and the history log 165. Some embodiments of the advertisement subsystem 150 have different and/or other modules than the ones described herein, and the functions can be distributed among the modules in a different manner than is described here. For example, while FIG. 2 shows a single advertisement subsystem 150 including modules for video store 205, temporal media ad store 210, user profile store 215, and training data store 240, in an embodiment these stores may be available in separate systems that communicate with each other for exchange of information.

The feature extractor 230 extracts the various features of users and videos that characterize the users and videos. The feature extractor 230 may extract information from various sources including the video store, user profile store 155, and the history log 165. Some features are extracted once for each user or video and are stored in the feature store 225, for example, age and gender. Other features may be periodically extracted and updated, for example, features that can change over time including the interests of the user or the geographical location of the user. The feature extractor can extract features related to time of presentation of the online content. For example, given the time of presentation of the content, the feature extractor can determine whether the content is being presented close to a holiday.

Various input features used for machine learning include characteristics of the user, characteristics of the content, and temporal information. The characteristics of the user used as input variables for learning comprise the age, gender, geographical location, ethnic background, education level, and the user's past choices including preferences specified by the user that determine the content presented to the user as well as the ads presented to the user. The temporal information used as input variables for learning include the time of the day, day of the week, day of the month, day/month/week in the year, or a measure of time difference compared to a specific holiday, for example, number of days relative to Christmas, New Year, or thanksgiving. Characteristics of the content used as input variables for learning include, a category of the content if available in the metadata, for example, romantic, musical, action, thriller, or comedy, a genre of music, specific artists associated with the content, whether the content in premium content or user-generated, and the age of the content indicating how long ago the content was produced. Other features used as input variable include length of time interval since the temporal media ad was presented to a user, number of ads that were played for the user previously, various criteria that can be specified by the advertiser for targeting a temporal media ad, user location, user ID, user tolerance of ads, length of the temporal media ad, textual content in the temporal media ad.

The model engine 245 provides estimates of playback times for each impression of the temporal media ad to the user based on historical data comprising playback times of users. The model engine 245 uses a model that is trained by machine learning techniques to predict playtimes of ads based on attributes of the user, attributes of the content and other factors. Examples of machine learning techniques that can be used include supervised learning, un-supervised learning, semi-supervised learning, and the like. The model engine 245 uses training data set to determine expected behavior in terms of playback time based on historical data. In an embodiment, the machine learning model used by model engine 245 provides a score indicative of a degree of certainty of the predicted playtime. The score value is used to help in selection of an advertisement to play if two or more advertisements have almost same value of predicted playtime. In this situation, the advertisement with the highest score indicating a certainty of the predicted playtime is selected for playing. In other words, outcomes with higher certainty are preferred over less certain outcomes if the predicted playtime values are close (i.e., within a threshold of each other).

In an embodiment, the playtime of an ad by a user is estimated based on a probability that the ad is viewed by the user for a particular length of time, as determined by the following equation:

t=P(full_ad)×t_ad+P(partial_ad)×E(fraction_ad|partial_ad)×t_ad (1)

In the above equation, t is the predicted playtime of the ad, P(full_ad) is the probability that the user views the full ad, t_ad is the time taken to view the full of the ad, P(partial_ad) is the probability that the user views the ad partially, E(fraction_ad|partial_ad) is the expected value of a fraction of the ad that is viewed, given the occurrence of the event that the ad was partially engaged. The equation can be assumed to include a probability component P(skip_ad)×0 modeling the probability that the ad is skipped, resulting in playtime of zero length. The various factors in the above equation can be modeled separately using machine learning models and combined. For example, the value of E(fraction_ad|partial_ad) can be determined for various ranges of fractions of ad that can be viewed by the user covering the entire range from the user skipping the ad to viewing the full ad.

The training module 255 obtains training data from the event logs 235 and stores it in the training data store 240. The training data store 240 stores training sets comprising tuples of videos, users, time of presentation of ads and the corresponding play times. The training module 255 trains the model for machine learning by taking the required data from training data store 240 as input. The resulting model comprises parameters necessary for predicting playtime given a combination of video, user, time of presentation of temporal media ad, and the temporal media ad, for example, parameters of a function based on least square regression model. Other machine learning methods that provide continuous outcomes can be used for predicting playtime, for example, tree-based models, kernel methods, neural networks, splines, or ensemble of one or more of these techniques. Other embodiments combine machine learning methods that determine continuous outcome value with machine learning methods that provide categorical outcome values (also called classifiers) based on Bayesian techniques.

In one embodiment, a combination of few (e.g., 2 or 3) ordinary least square regression models are used as prediction models by the model engine 245. A mixing distribution of the model is trained based on the data from the training data store 240. The components of the combination correspond to different possible ranges of playtimes of ads. For example, the components of the combination can be determined based on (1) instances of ads that are skipped almost immediately by the user, (2) instances of ads that are played to completion, and (3) ads which are partially skipped after a portion of the temporal media ad has played. A machine learning model is used for prediction corresponding to each component.

A selector model is trained to determine the probability that a temporal media ad corresponds to a particular case, (1), (2), or (3) described above. At runtime, for a given input comprising a user, video, and a temporal media ad, the selector model is used to determine the probabilities that the input corresponds to the different least square regression models. The least square regression model with the highest probability is selected for predicting the playtime for the input. For example, for a given user, video, and ad combination, the selector model determines that the probability of the ad being skipped is 0.1, the probability of the ad being played to completion is 0.2 and the probability of the ad being partially skipped is 0.7. Therefore, the highest probability corresponds to the ad being partially skipped which is case (3) described above. Accordingly, the model corresponding to case (3) is used to predict the playtime for the input user, video, and ad combination.

The temporal media ad selector 220 selects a set of candidate ads that can be presented along with a video to a user. The selection of the temporal media ad is based on the temporal media ad targeting criteria specified by the advertiser. The temporal media ad selector 230 compares the temporal media ad targeting criteria with attributes of the user, attributes of the content and temporal information, for example, time of the day, day of the week etc. if applicable. The temporal media ad selector 220 can also use other factors to determine the ads to be presented to a user including the number and types of ads that were recently presented to the user. For example, if the number of ads presented to a user in a given time interval exceeds a threshold, the temporal media ad selector 220 may decide not to present any ads to the user for certain time. The list of candidate ads that can be presented to the user as selected by the temporal media ad selector 230 is provided to the bidding module 250 to determine the winning temporal media ad to be presented to the user. A matching score can be determined for each ad that is a candidate ad for a user and video combination. The matching score depends on a degree of match of the ad with the user and video based on the ad targeting criteria provided by the advertiser. For example, if a user and video combination meets several ad targeting criteria including, age of the user, gender of the user, location of the user, and the type of video, the matching score for the ad is higher than the score of a user and video that match only one ad targeting criteria. In an embodiment, the different criteria can be weighed and the matching score determined as a weighted aggregate score value. If a large number of target ads match a user and video, the matching score of the ads is used to select the best matching ads as candidate ads for presentation to the user.

The bidding module 250 selects a winning temporal media ad from a given set of ads selected by the temporal media ad selector 220 for a given user requesting a video. The bidding module 250 selects the temporal media ad that is likely to maximize the revenue based on cost per second specified by the advertiser 130 for the temporal media ad and the predicted playtime of the temporal media ad. The bidding module 250 determines the winning temporal media ad based on an auction scheme, for example, the second price auction scheme. In the second price auction scheme, the cost charged to the advertiser is determined based on the actual playtime of the temporal media ad and the cost per second specified by the runner up bid in the auction. The runner up bid is the second highest bid as determined by the product of cost per second bid for the ads and the predicted playtime of the ads. In this embodiment, the paid cost by an advertiser paid_CPS for a temporal media ad presented is determined using equation (2).

$$paid\_CPS = runnerup\_bid \_per \_sec * \frac{runnerup\_predicted \_playtime}{winner\_predicted \_playtime} \qquad ( 2 )$$

In equation (2), the runnerup_bid_per_sec is the value of cost per second that was bid by the runner up advertiser, the runnerup_predicted_playtime is the predicted playtime of the runner up temporal media ad, and the winner_predicted_playtime is the predicted playtime of the winner temporal media ad. In an embodiment that predicts playtime of an ad using a combination of multiple ordinary least square regression models, the runnerup_predicted_playtime and the winner_predicted_playtime are predicted using one of the prediction models of the combination. The prediction model that is used for predicting the playtime is selected using the selector model. In other embodiments, the playtime of the ad can be predicted using a single model that takes the features of a video, user, and ad as input and predicts the playtime of the ad. The value of paid_CPS is proportional to the predicted cost that would be paid by the runner up temporal media ad as estimated by runnerup_bid_per_sec*runnerup_predicted_playtime. The value of paid_CPS is inversely proportionate to the value of winner_predicted_playtime. For example, the value of winner_predicted_playtime can be high resulting in high revenue generated by presenting the winner temporal media ad, even with a relatively low value of cost per second bid by the winner compared to runnerup_bid_per_sec.

The actual cost charged to the advertiser for the winning temporal media ad is the value of paid_CPS multiplied with the actual playtime of the temporal media ad. Accordingly, the advertiser only pays for the amount of time that the user was engaged viewing the temporal media ad as determined by the playtime of the temporal media ad. The advertiser 130 can also be provided with valuable feedback in terms of how long users view a temporal media ad before skipping it. This feedback allows the advertiser 130 to improve their ads to achieve higher playtimes.

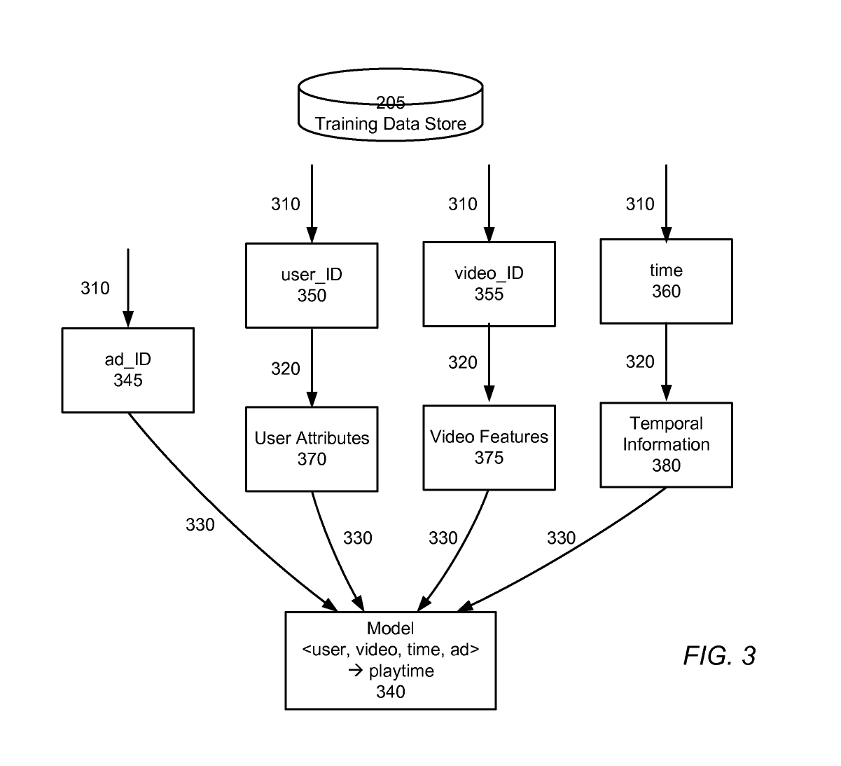

FIG. 3 shows a data flow diagram illustrating the interaction between various types of data stored in the advertisement subsystem 150 for training a model for predicting playtime for ads, according to one embodiment. The training data store 205 stores historical data comprising playback times for ads presented to users along with specific videos at a given time. The training module 225 extracts the information for training a model for predicting playtime of ads. The training module 225 extracts 310 a tuple comprising <user_ID, video_ID, time, temporal media ad_ID>; this is the temporal media ad_ID 345 of a temporal media ad presented to a user identified by user_ID 350 along with a video identified by video_ID 365 at time 360. The training module retrieves 320 the features of the temporal media ad, user, and time from the feature store 225 if the features were previously extracted by the feature extractor 230. If the features were not previously extracted for the corresponding user or temporal media ad, the training module 225 invokes 320 the feature extractor 230 to extract the features. The features for the user and the video correspond to the attributes of the user described herein, for example, the age, gender, geographical location, language, ethnic background, other demographic information for the user. The features of the video include the artist information, a genre of music, a specific television series, a category of video content, or premium vs. user-generated content and other attributes of the video. The features related to time 360 correspond to temporal information including the time of the day, day of the week, and the like. The training module 225 uses the extracted features to train 330 the model 340 for predicting playtime for a temporal media ad based on a user, video, time of presentation of the temporal media ad. The model 340 can comprise a regression function that computes a continuous value for the playtime or the model. In an embodiment, the model 340 can be a classifier that returns one of a set of playtime ranges.

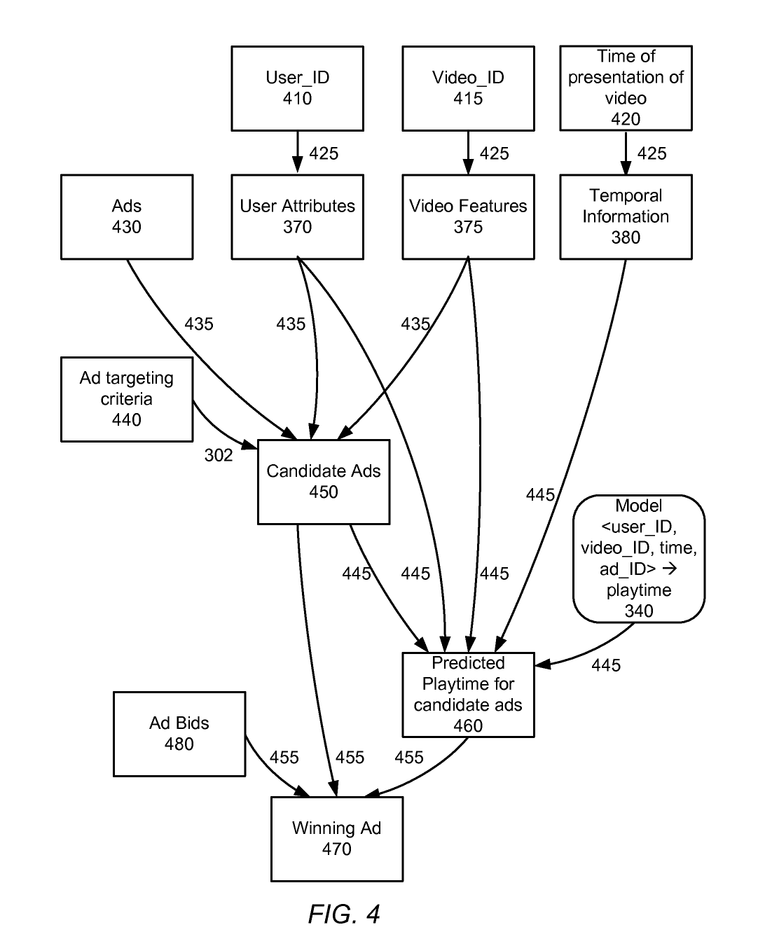

FIG. 4 shows a data flow diagram illustrating the interaction between various types of data stored in the advertisement subsystem 150 for determining a winning temporal media ad from a set of candidate ads selected for presentation to a user along with a video. The video serving module 135 identifies a video with video_ID 415 for presentation to the user with user_ID. The temporal media ad selector 220 obtains 425 the features of the user and the video comprising the user attributes 370 and the video features 375 from the feature store 225 if available. Alternatively, the temporal media ad selector 220 can invoke the feature extractor 230 to extract the features. The temporal media ad selector 220 also invokes the feature extractor 230 to extract temporal information based on the time 420 of presentation of the video. The temporal media ad selector 220 selects 435 a set of candidate ads 450 for presentation to the user and the content combination specified by <user_ID, video_ID>. The temporal media ad selector 220 selects the candidate ads 450 from the available ads 430 by applying the temporal media ad targeting criteria 440 to the user attributes 370 and the video features 375.

A winning temporal media ad is selected from the set of candidate ads 450 for presentation to the user. The model engine 245 applies the model 340 for determining predicted playtime 460 for candidate ads 450 based on user attributes 370, video features 375, and temporal information 380. The model 340 allows a combination of <user_ID, video_ID, time, temporal media ad_ID> to be mapped to a predicted playtime 460. The bidding module 250 uses an auction scheme to determine 455 a winning temporal media ad 470 from the candidate ads 450 based on their predicted playtimes 460 and the temporal media ad bids 480 provided by the advertiser. The winning temporal media ad 470 is presented to the user with user_ID 410 along with the video with video_ID 415. The actual playtime of the temporal media ad is utilized by the advertisement subsystem 150 for determining the cost of presentation of the temporal media ad charged to the advertiser.

In sum, embodiments of the invention select a temporal media ad to be presented to a user based on predicted playtimes of the ads for the user as determined by machine learning techniques. The advertisers provide temporal media ad targeting criteria to determine the potential users to whom the ads should be targeted. The advertisers further provide bids based on cost per second of presentation of the temporal media ad and are charged based on the length of time that the temporal media ad is viewed by the user. Accordingly, if the user skips the temporal media ad after viewing it for a very short period of time, the advertiser is charged less compared to an instance where the user views the temporal media ad to completion.

### Computer Architecture

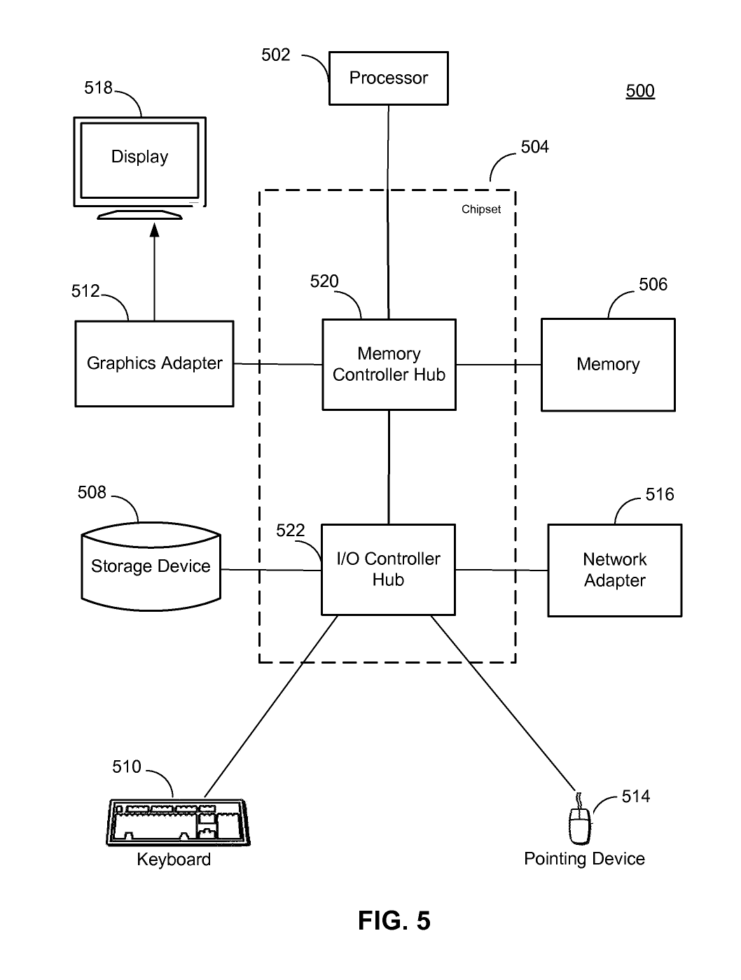

FIG. 5 is a high-level block diagram illustrating an example computer 500, such as a computer running the video hosting service 100 shown in FIG. 1. The computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

The storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and is used in combination with the keyboard 510 to input data into the computer system 500. The graphics adapter 512 displays images and other information on the display 518. The network adapter 516 couples the computer system 500 to one or more computer networks.

The computer 500 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 508, loaded into the memory 506, and executed by the processor 502.

The types of computers 500 used can vary depending upon the embodiment and requirements. For example, a computer system used for a bidding system might include one or more blade computers lacking displays, keyboards, and/or other devices shown in FIG. 5. Likewise, a computer system used as a client device 110 might comprise a mobile phone or other such device with a touch-sensitive display and limited processing power.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having,” “by,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for compression and decompression of images and videos based on block prediction. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

We claim:

1. A method performed by a computer system for selecting a temporal media ad for presentation with online content, the method comprising:
receiving by the computer system bids for presenting online ads with media content to users, wherein each bid is based upon a cost per unit time of temporal media ad presentation;
identifying an online content for online presentation to a user;
selecting a set of candidate ads for online presentation to the user;
determining a predicted playtime by the user for each candidate temporal media ad in the set of ads based on previous playtimes of ads by a set of users when presented with ads with online content; and
selecting a temporal media ad from the candidate set of ads based on the predicted playtime of each temporal media ad and the bid for presentation of each temporal media ad.

2. The computer implemented method of claim 1, further comprising:
presenting the selected temporal media ad to the user with the online content; and
determining a cost for presenting the temporal media ad based on the actual playtime of the selected temporal media ad.

3. The computer implemented method of claim 1, further comprising:
receiving a set of attributes for target audience for each temporal media ad, wherein selecting a candidate set of ads comprises matching of attributes of the user with attributes for target audience for each temporal media ad.

4. The computer implemented method of claim 1, further comprising:
receiving a set of attributes for the target media content for each temporal media ad, wherein selecting a candidate set of ads comprises matching of attributes of the media content with attributes for target media content of each temporal media ad.

5. The computer implemented method of claim 1, wherein the temporal media ad selected from the plurality of ads is the temporal media ad with maximum estimated revenue as determined from the predicted playtime and the cost per unit time of presentation of the temporal media ad.

6. The computer implemented method of claim 1, wherein the temporal media ad selected from the plurality of ads is the temporal media ad with maximum value of a product of predicted playtime and the cost per unit time of presentation of the temporal media ad.

7. The computer implemented method of claim 1, wherein each temporal media ad is a temporal media ad comprising at least one of a video and an audio presentation.

8. The computer implemented method of claim 1, wherein selecting a temporal media ad from the set of candidate ads is based on an auction based on estimates of revenue from the candidate ads.

9. The computer implemented method of claim 1, wherein selecting a temporal media ad from the set of candidate ads is based on a second price auction based on estimates of revenue from the candidate ads.

10. The computer implemented method of claim 1, further comprising:
determining a runner up with a second highest value of product of predicted playtime and cost per unit time of temporal media ad presentation; and
determining a cost of presentation of the selected temporal media ad based on a cost per unit time of the runner up temporal media ad.

11. The computer implemented method of claim 10, wherein cost of presentation of the selected temporal media ad is further based on the ratio of predicted playtime of the runner up temporal media ad and the predicted playtime of the selected temporal media ad.

12. The computer implemented method of claim 1, wherein determining a predicted playtime is based on a least squares regression model.

13. The computer implemented method of claim 1, wherein determining a predicted playtime is based on a combination of a plurality of least squares models.

14. The computer implemented method of claim 13, wherein the plurality of least squares models comprises:
a first model based on instances of ads skipped before a first threshold length of time interval is reached;
a second model based on instances of ads skipped after a second threshold length of time interval is reached, the second threshold being greater than the first threshold; and
a third model based on instances of ads skipped after a time interval greater than the first threshold and less than the second threshold.

15. The computer implemented method of claim 13, further comprising, determining a probability that each candidate temporal media ad corresponds to each least squares model in the plurality of least squares models.

16. The computer implemented method of claim 1, wherein the predicted playtime of temporal media ad by a user is determined from a length of time interval since a previous temporal media ad was presented to the user.

17. The computer implemented method of claim 1, wherein the predicted playtime of temporal media ad by a user is determined from a rate at which ads were presented to the user in past.

18. The computer implemented method of claim 1, wherein the predicted playtime of temporal media ad by a user is determined based on a time of the day during which the temporal media ad is expected to be presented.

19. The computer implemented method of claim 1, wherein the predicted playtime of temporal media ad by a user is determined based on a day of the week during which the temporal media ad is expected to be presented.

20. The computer implemented method of claim 1, wherein the predicted playtime of temporal media ad by a user is determined based on a temporal proximity to a holiday.

21. The computer implemented method of claim 1, wherein the predicted playtime of temporal media ad by a user is determined based on demographic information describing the user.

22. The computer implemented method of claim 1, wherein the predicted playtime of temporal media ad by a user is determined based on an ethnic background of the user.

23. A method performed by a computer system for generating a model for predicting playtime of a media ad for presentation with content, the method comprising:
receiving by the computer system a plurality of tuples comprising information identifying a content, a user, and an ad, and a value of playtime that the ad was played by the user when presented with the content;
for each tuple, identifying features describing the video and the user;
generating a plurality of prediction models that determine a playtime value for an input tuple comprising information identifying an input content, an input user, and an input ad, wherein each prediction model is associated with a range of playtime value;
generating a selector model that selects a prediction model for the input tuple, wherein the selector model selects the prediction model by:
determining a score value corresponding to each range of playtime, the score value indicating a likelihood of the playtime value for the input tuple belonging to the range; and
selecting the prediction model with the highest score value; and
storing the prediction model.

24. The computer implemented method of claim 23, wherein each prediction model is a least squares regression model.

25. The computer implemented method of claim 23, wherein the playtime value is used to select an ad from a set of ads, each ad associated with a cost per unit time, the selection of the ad comprising:
determining a measure of revenue for each ad based on a product of playtime and cost per unit time corresponding to the ad; and
selecting the ad based on the measure of the revenue for the ad.

26. A computer-implemented system for selecting a temporal media ad for presentation with media content, the system comprising:
a computer processor; and
a computer-readable storage medium storing computer program modules configured to execute on the computer processor, the computer program modules comprising: a temporal media ad store module configured to:
receive bids for presenting ads with media content to users, wherein each bid is based upon a cost per unit time of temporal media ad presentation;
a video server module configured to:
identify an online content for presentation to a user;
a temporal media ad selector module configured to:
select a candidate set of ads for presentation to the user;
a model engine configured to:
determine a predicted playtime by the user for each temporal media ad in the candidate set of ads based on previous playtimes of ads by a set of users when presented with online contents with ads; and
select a temporal media ad from the candidate set of ads based on the predicted playtime of each temporal media ad and the cost per unit time of presentation of each temporal media ad.

27. A computer program product having a computer-readable storage medium storing computer-executable code for selecting a temporal media ad for presentation with media content, the code comprising:
a temporal media ad store module configured to:
receive bids for presenting ads with media content to users, wherein each bid is based upon a cost per unit time of temporal media ad presentation;
a video server module configured to:
identify an online content for presentation to a user;
a temporal media ad selector module configured to:
select a candidate set of ads for presentation to the user;
a model engine configured to:
determine a predicted playtime by the user for each temporal media ad in the candidate set of ads based on previous playtimes of ads by a set of users when presented with online contents with ads; and
select a temporal media ad from the candidate set of ads based on the predicted playtime of each temporal media ad and the cost per unit time of presentation of each temporal media ad.
